(19) United States
(12) Patent Application Publication
(10) Pub. No.: US 2025/0132577 A1
(43) Pub. Date: Apr. 24, 2025

(54) SCALABLE BATTERY SYSTEM AND METHOD

(71) Applicant: Caterpillar Inc., Peoria, IL (US)

(72) Inventors: Timothy Beetler, Peoria, IL (US); Brian R. Bell, West Lafayette, IN (US); Jose D. Miranda, Peoria, IL (US); C. Brahm Landis, Indianapolis, IN (US)

(73) Assignee: Caterpillar Inc., Peoria, IL (US)

(21) Appl. No.: 18/490,936

(22) Filed: Oct. 20, 2023

(51) Int. Cl. H02J 7/00; H01M 10/42; H01M 50/51; H02J 7/14

(52) U.S. Cl. CPC H02J 7/00304; H01M 50/51; H02J 7/00041; H02J 7/0018; H02J 7/1423; H01M 2010/4271; H01M 2220/20

(57) ABSTRACT

Various control systems and methods are discussed including a method of controlling a battery pack id disclosed, the method optionally including: providing a plurality of battery strings each having an identical construction, each battery string including a plurality of battery cells connected in series, wherein each of the plurality of battery strings is connected to a respective pair of contactors; providing a sensor configured to measure at least one of a voltage and a current of each of the plurality of battery strings, wherein respective sensor is electrically connected to an electronic controller; and selectively controlling individually ones of the plurality of battery strings to meet a requirement with the electronic controller based upon measurement from each sensor.

### TECHNICAL FIELD

This document relates to rechargeable battery technology and in particular to techniques of using one or more identically constructed battery packs and battery strings to power large moving work machines.

### BACKGROUND

Powering a large moving work machine (e.g., industrial equipment such as earth moving equipment) with an electric motor requires a large mobile electric energy source that can provide current of tens to hundreds of Amperes (Amps). Multiple large capacity battery cells connected in parallel as battery strings can provide the sustained energy power needed by a large electric-powered moving work machine. However, when multiple battery strings are connected in parallel, this creates a complex system that must be controlled adequately for safety, reliability and performance. For example, with typical battery architecture it is necessary to avoid connecting battery cells that differ too much in their state of charge. Failure to avoid this would result in high currents and can cause potential damage to the batteries when the battery charge of the multiple battery cells tries to equalize between the battery strings.

### SUMMARY OF THE INVENTION

According to one example, a control system for a battery pack, optionally including a plurality of battery strings each having an identical construction, a plurality of contactors, a plurality of sensor and an electronic controller is disclosed. Each battery string including a plurality of battery cells connected in series. The plurality of contactors each optionally having an identical construction. Each battery string has a respective pair of the plurality of contactors with one of the respective pair connected to a positive terminal and a second of the respective pair connected a negative terminal of each battery string. Each of the plurality of battery strings has a respective one of the plurality of sensors configured to measure at least one of voltage and current. The electronic controller connected to the plurality of sensors and the plurality of contactors. The electronic controller is configured to control each of the plurality of battery strings individually to meet a system requirement based upon measurement from the plurality of sensors.

According to another example, a method of controlling a battery pack id disclosed, the method optionally including: providing a plurality of battery strings each having an identical construction, each battery string including a plurality of battery cells connected in series, wherein each of the plurality of battery strings is connected to a respective pair of contactors; providing a sensor configured to measure at least one of a voltage and a current of each of the plurality of battery strings, wherein each respective sensor is electrically connected to an electronic controller; and selectively controlling individually ones of the plurality of battery strings to meet a requirement with the electronic controller based upon measurement from each sensor.

According to yet another example, a method of flexibly scaling a battery system is disclosed. The method optionally including: providing a baseline battery pack comprising a plurality of battery strings each of the plurality of battery strings having an identical construction; controlling individual ones of the plurality of battery strings to meet a requirement with an electronic controller; adding one or more additional battery strings having the identical construction to the baseline battery pack to increase power output; wherein the identical construction includes, a same architecture and same components for each of the plurality of battery strings including the one or more additional battery strings enabling interchangeably adding battery strings without reconfiguring the electronic controller.

### BRIEF DESCRIPTION OF THE DRAWINGS

FIG. 1 is an elevation view depicting an example working machine in accordance with this disclosure.

FIG. 2 is a schematic diagram of a modular battery system for a work machine according to one example of the present application.

FIG. 3 is a schematic diagram of a plurality of battery strings of a battery pack according to one example of the present application.

FIG. 4 is a schematic diagram of a battery string according to another example of the present application.

FIG. 5 is a method of scaling a battery pack according to an example of the present application.

### DETAILED DESCRIPTION

Examples according to this application are directed to methods and systems including for a battery pack architecture and for systems and methods that control the battery pack at a battery string level. The battery system can include one or more battery packs with multiple battery strings of battery cells. The construction (e.g., the architecture and components) of the multiple battery strings can be identical (i.e., entirely the same).

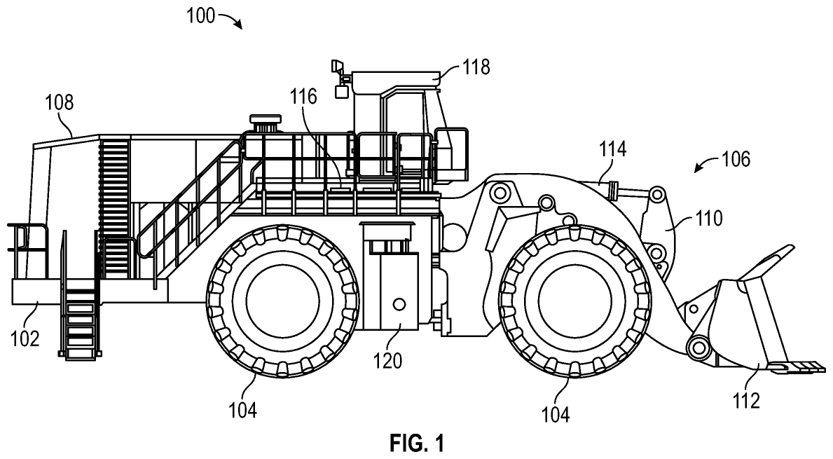

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various heavy industries, including, as examples, construction, agriculture, earth moving, forestry, mining, transportation, material handling, waste management, and so on. Accordingly, although a number of examples are described with reference to a wheel loader machine, examples according to this disclosure are also applicable to other types of machines including graders, scrapers, dozers, excavators, compactors, material haulers like dump trucks, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 114. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. As an example, machine 100 can be used to excavate a portion of a work site by actuating cylinders 114 to articulate bucket 112 via linkage 110 to dig into and remove dirt, rock, sand, etc. from a portion of the work site and deposit this load in another location.

Machine 100 can include a battery compartment connected to frame 102 and including a modular battery system 120. Battery system 120 is electrically coupled to the one or more electric motors of the machine 100.

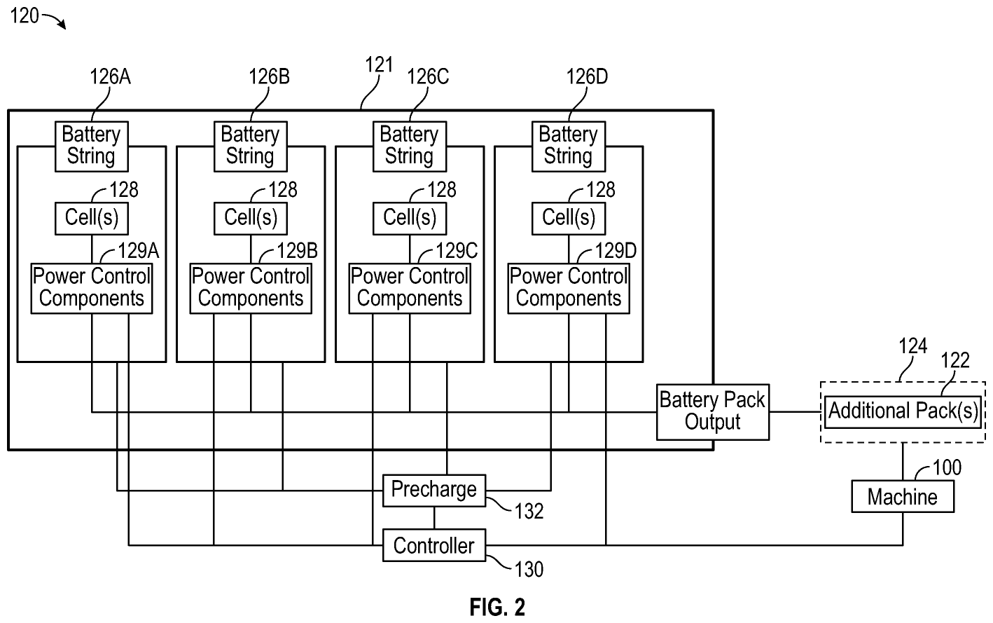

FIG. 2 is a block diagram of the modular battery system 120 according to one example. The battery system 120 can be used to provide power to the machine 100. The battery system 120 includes a battery pack 121 and optionally one or more additional battery packs 122 (e.g., two to eight battery packs). These battery packs 121, 122 can be electrically connected together in parallel or series by a bus 124. Advantageously, the additional battery packs 122 can have an identical construction (e.g., a same architecture, same components, same size and same shape) as the battery pack 121 such that modular mechanical coupling to the bus 124 can be accomplished in a relatively straight forward manner. In particular, the bus 124 and other mechanical components do not need to be designed to accommodate packs of different sizes, shapes, architecture, components etc. Because the battery system 120 is modular, and the battery packs 121, 122 can be interchangeable on the bus 124, less battery packs can be connected in parallel for smaller battery systems, and more battery packs can be connected in parallel for larger battery systems. Each of the battery packs 121, 122 includes multiple battery strings 126A, 126B, 126C and 126D (e.g., two to six battery strings). Although four battery strings 126A, 126B, 126C and 126D are illustrated in FIG. 2 for the battery pack 121, this is merely for exemplary purposes. Each of the battery strings 126A, 126B, 126C and 126D can have an identical construction (e.g., the same architecture and same components). The battery strings 126A, 126B, 126C and 126D of the battery pack 121 are illustrated in FIG. 2 for simplicity with the understanding that the battery pack(s) 122 can have battery strings sharing the identical construction of the battery strings 126A, 126B, 126C and 126D.

The battery pack 121 can be connected together in series or parallel with the battery back 122. As discussed above, the battery pack 122 can have a second plurality of strings having the identical construction of the plurality of battery strings 126A, 126B, 126C and 126D of the battery pack 121. This construction allows for modularly expanding a power output of the battery on the pack or system (module level) by adding an additional one or more battery strings having the identical construction. Additionally, as discussed below, the identical construction of the battery strings enables interchangeably adding battery strings without reconfiguring a controller to accommodate various different components and different architectures at either the string level or the pack level.

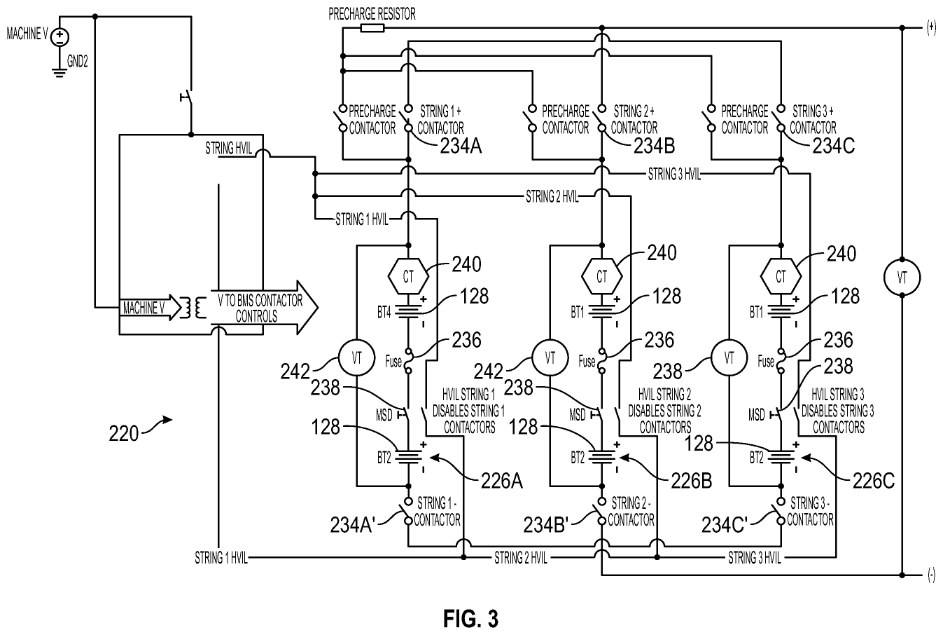

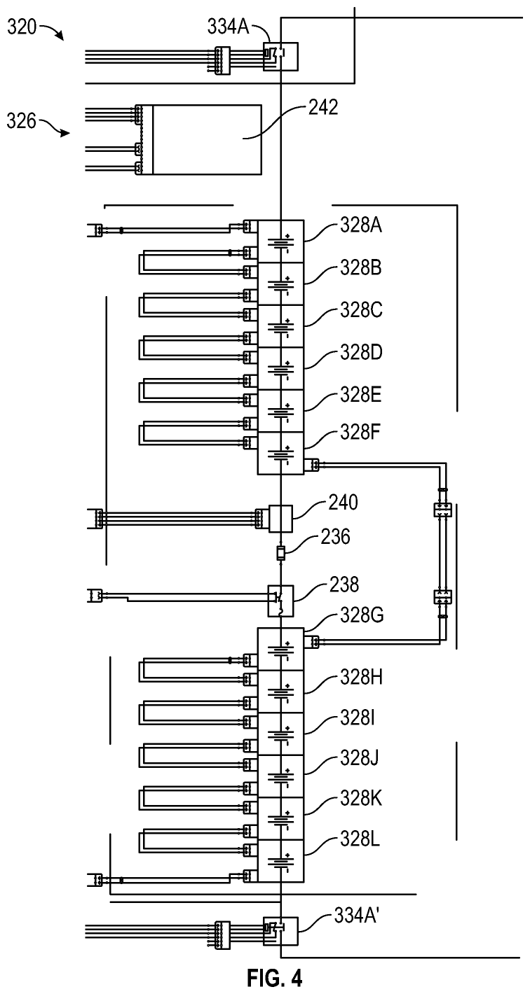

The battery strings 126A, 126B, 126C and 126D can be electrically connected together in parallel. Each battery string 126A, 126B, 126C and 126D includes a plurality of cells 128 electrically connected in series. Each of the plurality of cells can have about 3 volts to 4 volts of electric potential. The plurality of cells 128 are linked together in series to form strings that reach a nominal voltage for the battery pack 121. The battery strings 126A, 126B, 126C and 126D can be linked together in parallel to combine an output power for the battery pack 121 to raise the current that the battery pack 121 can discharge at. As an example, the battery pack 121 or combination of the battery pack 121 and the one or more additional packs 122 can be rated for: from 350-800 Volts, 1000-1500 amps, and/or 30-60 kilowatt-hours. Each of the battery strings 126A, 126B, 126C and 126D can include components 129A, 129B, 129C and 129D including power control components that will be discussed in further detail subsequently with regard to FIGS. 3 and 4.

At a system level, the battery pack 121 can include a controller 130 and a precharge circuit 132. The controller 130 can be electrically connected with the precharge circuit 132, the battery strings 126A, 126B, 126C and 126D and the components 129A, 129B, 129C and 129D including the power control components. The controller 130 can be configured to control the battery pack on the battery string level. This control can be control of individual of the battery strings 126A, 126B, 126C and 126D to meet system requirements (e.g., desired amps, amp-hours, kilowatts, kilowatt-hours, etc.). Put another way, the present battery system 120 has a single battery pack level controller (the controller 130) for all control functions including for control of the power control components. The present battery system 120 does not contemplate sub-controllers or sub-routines for each of the battery strings 126A, 126B, 126C and 126D. Rather, at the system level the controller 130 can be configured to manage the function of the battery strings 126A, 126B, 126C and 126D and the components 129A, 129B, 129C and 129D. This is in contrast to most power control circuits that are multi-tiered and complex so as to control operation of the battery system at the pack level and at the string level with the circuits having to address various differently constructed battery strings, component construction and architecture at the system or string level.

The controller 130 can be, for example, a pack controller circuit such as an energy control module or ECM. The controller 130 can control various functions and can include processing circuitry that includes logic to perform the functions described herein. The processing circuitry may include a microprocessor, application specific integrated circuit (ASIC), field programmable gate array (FPGA), or other type of processor, interpreting or executing instructions in software or firmware. In some examples, the controller 130 includes a logic sequencer circuit. A logic sequencer refers to a state machine or other circuit that sequentially steps through a fixed series of steps to perform the functions described. A logic sequencer circuit can be implemented using hardware, firmware, or software.

The precharge circuit 132 can be a single pre-charge circuit at the pack level, but it can include a separate precharge contactor (not shown) for each of the battery strings 126A, 126B, 126C and 126D for selecting any of battery strings 126A, 126B, 126C and 126D within the battery pack 121 to pre-charge from. The precharge circuit 132 can be used to precharge the load when the bringing the battery system 120 online to supply the load. The precharge contactors each includes a contact resistance to limit the current when bringing the battery system 120 online. Any of the battery strings 126A, 126B, 126C and 126D can be chosen as the first battery string connected to the load.

FIG. 3 is a schematic diagram showing another example of a battery system 220 for a battery pack. The battery system 220 can have a construction similar to that of the battery system 120 discussed previously but includes further detail as to the construction of battery strings and other components. The battery system 220 can include a plurality of battery strings 226A, 226B and 226C and battery contactors 234A, 234A′ 234B, 234B′ and 234C, 234C′. Although three battery strings 226A, 226B and 226C are shown in FIG. 3, this number is purely exemplary. Each of the battery strings 226A, 226B and 226C can include the cells 128, a fuse 236, a disconnect 238, a current sensor 240 and a voltage sensor 242. FIG. 3 additionally illustrates precharge contactors previously discussed in FIG. 2.

For each the battery strings 226A, 226B and 226C, the plurality of battery cells 128 are electrically connected in series. The battery strings 226A, 226B and 226C each have an identical construction that includes a same architecture and same components (e.g., the identical parts are used for the cells 128, the fuse 236, the disconnect 238, the current sensor 240 and the voltage sensor 242 and the same series connection is used). This same architecture and same components enables the battery strings 226A, 226B and 226C to be interchangeably added or removed without reconfiguring the electronic controller. Similarly, the battery contactors 234A, 234A′ 234B, 234B′ and 234C, 234C′ can each have an identical construction. Each battery string 226A, 226B and 226C has a respective pair of the battery contactors 234A, 234A′ 234B, 234B′ and 234C, 234C′ with one of the respective pair (234A, 234B and 234B) connected to a positive terminal and a second of the respective pair (234A′, 234B′ and 234C′) connected a negative terminal of each battery string 226A, 226B and 226C. Due to the identical construction and parallel connection of the battery strings 226A, 226B and 226C, the battery contactors 234A, 234A′ 234B, 234B′ and 234C, 234C′ can each be rated for delivering less than the maximum current that can be provided by the battery pack. In certain examples, the battery contactors 234A, 234A′ 234B, 234B′ and 234C, 234C′ are rated to withstand 100 Amps or less. The output power of the battery strings 226A, 226B and 226C connected in parallel exceeds a rated power output of any one of the contactors 234A, 234A′ 234B, 234B′ or 234C, 234C′. The battery contactors 234A, 234A′ 234B, 234B′ and 234C, 234C′ control the connection of the battery string 226A, 226B and 226C to the electrical load placed between the battery string and the battery pack bus on both the positive and negative legs.

The cells 128, the fuse 236, the disconnect 238 and the current sensor 240 can be connected in series with at least one of the cells 128 on one side of the fuse 236 and the disconnect 238 from another one or more of the cells 128. The voltage sensor 242 can be configured to measure a voltage across the respective battery string 226A, 226B or 226C. Although both the current sensor 240 and the voltage sensor 242 are shown in FIG. 3, both sensors are not required according to some examples. As an example, the voltage sensor 242 can be an analog-to-digital converter (ADC) that monitors the string voltage and produces a digital value representative of the highest offline string voltage.

The controller (e.g., controller 130 of FIG. 2) can be electronically connected to the battery contactors 234A, 234A′ 234B, 234B′ and 234C, 234C′, the current sensor 240 and the voltage sensor 242 (examples of the power control components referenced in FIG. 2). The controller can be configured communicate with and receive data (measurement) from the current sensor 240 and the voltage sensor 242. Thus, the controller can receive online voltage (discharging state), offline voltage, precharge, etc. measurement from the current sensor 240 and the voltage sensor 242. As an example, the highest voltage can be of interest, and controller determines the highest voltage of one or up to all of the battery strings 226A, 226B or 226C. The controller (e.g., controller 130 of FIG. 2) can be configured to connect and disconnect (open and close) the battery contactors 234A, 234A′ 234B, 234B′ and 234C, 234C′ in the manner of switches. Put another way, the controller can be configured to selectively connect or disconnect each of the battery strings 226A, 226B or 226C by controlling the respective pair of contactors 234A, 234A′ 234B, 234B′ or 234C, 234C′ for each battery string based on the measurement of the respective sensor (e.g., the current sensor 240 and/or the voltage sensor 242). Thus, the controller is a single battery pack level controller for all the battery contactors 234A, 234A′ 234B, 234B′ and 234C, 234C′. Put simply, the controller can be configured to control each of the battery strings 226A, 226B or 226C individually (and collectively) to meet a system requirement (e.g., desired amps, amp-hours, kilowatts, kilowatt-hours, etc.) based upon measurement from the sensor (e.g., the voltage sensor 242 or the current sensor 240). The controller can be configured to increase power output of the battery pack by selectively commanding applicable of the contactors 234A, 234A′ 234B, 234B′ and/or 234C, 234C′ to connect additional of the plurality of battery strings 226A, 226B and/or 226C. The controller can be configured to selectively decrease power output of the battery pack by selectively commanding applicable of the contactors 234A, 234A′ 234B, 234B′ and/or 234C, 234C′ to disconnect one or more of the battery strings 226A, 226B and/or 226C.

As an example, the controller based upon system requirement checks the current sensor 240 and/or the voltage sensor 242 and determines whether an offline battery string 226A, 226B or 226C should go online. If criteria are met, the controller connects one or more of battery string 226A, 226B or 226C to the battery bus and connects the battery bus to the load bus. Battery strings that were online can be brought offline in a similar manner (e.g., by sorting from lowest to highest voltage, determining required current based upon system requirement, etc.). Each battery string can be controlled independently of the other battery strings.

FIG. 4 shows a schematic diagram of a single battery string 326 of a system 320. The understanding is the system 320 would include additional battery strings having an identical construction to that of the battery string 326. Additionally, the system 320 can include battery contactors 334A, 334A′ having a construction similar to those previously discussed. The battery string 326 can include the cells AA (in particular, cells 328A, 328B, 328C, 328D, 328E, 328F, 328G, 328H, 328I, 328J and 328K), the fuse 236, the disconnect 238, the current sensor 240 and the voltage sensor 242. The construct of the battery string 326 is thus similar to the battery string 226 (FIG. 3) discussed previously including the fuse 236, the disconnect 238, the current sensor 240 and the voltage sensor 242 but includes more cells 328A, 328B, 328C, 328D, 328E, 328F, 328G, 328H, 328I, 328J, 328K and 328L connected together in series.

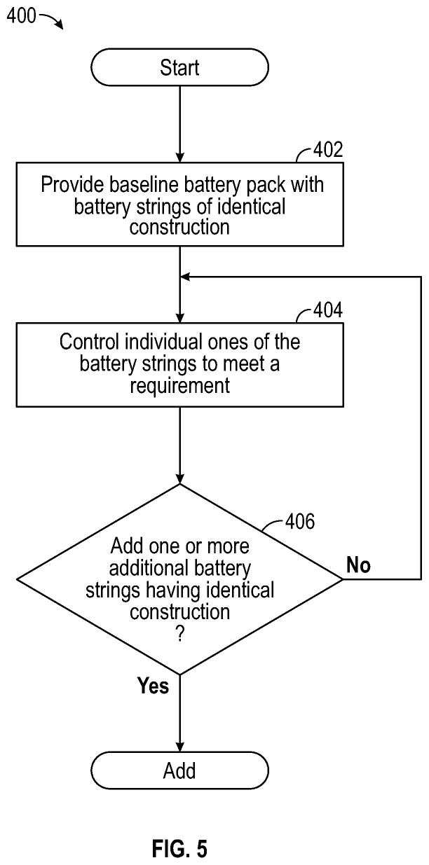

FIG. 5 is a flow diagram of a method 400 of scaling a battery system. The method 400 can include providing 402 a baseline battery pack comprising a plurality of battery strings each of the plurality of battery strings having an identical construction. The method 400 can include controlling 404 individually ones of the plurality of battery strings to meet a requirement with an electronic controller. The method 400 can inquire (e.g., query a system requirement) about adding 406 (or replacing or dropping) one or more additional battery strings having the identical construction to the baseline battery pack to increase power output. As used in the method 400, the identical construction includes a same architecture and same components for each of the plurality of battery strings including the one or more additional battery strings enabling interchangeably adding battery strings without reconfiguring the electronic controller.

Optionally, the method 400 can include adding the one or more additional battery strings includes adding one or more battery packs having an identical construction to the baseline battery pack. The method 400 can include modularly expanding a power output of the battery pack by adding an additional one or more battery strings having the identical construction. The plurality of battery strings and the one or more additional battery strings can be connected in parallel to combine the output power for the battery pack. The method 400 can include adding one or more of the plurality of battery strings in parallel to increase an output current capacity of the battery pack.

The output power of the plurality of battery strings and the one or more additional battery strings connected in parallel can exceed a rated power output of one or more of the same components. For example, the output power of the plurality of battery strings connected in parallel can exceed a rated power output of any one of a respective pair of contactors for a single battery string. Each of the respective pair of contactors can be rated to 100 Amperes or less while the output power of the plurality of battery strings can be 350 Amperes or more, for example.

### INDUSTRIAL APPLICABILITY

The present application discloses one or more battery packs (e.g., battery pack 121 and/or 122) having a modular design that includes battery strings (e.g., battery strings 126A, 126B, 126C and 126D or 226A, 226B, 226C or 326) sharing a same common construction. The identical construction of each of the plurality of battery strings includes a same architecture and same components. This same architecture and same components enables the plurality of battery strings to be interchangeably added or removed (connected or disconnected) to provide a desired power output or a desired output current capacity of the battery pack. This allows the battery strings to be used in any number and be combined with battery strings of other battery packs that share the identical construction. In this manner the battery packs discussed can be combined to obtain a system to achieve the overall energy capacity desired. The control architecture utilized need not be modified from battery string to battery string or from battery pack to battery pack as the same control logic/methodology/algorithms can be used as the battery strings have identical construction. Overall system control can be based on a single similar circuit control. As an example, if battery strings need to be added to the overall system to increase output current capacity, two to four (or more) of the same systems can be added in parallel. These systems can all controlled by the same pack level controller using the same control logic/methodology/algorithms.

The common construction for the plurality of battery strings has additional benefits. For example, it is easier to validate performance and reliability of the battery pack as this can be accomplished on the small level (say at the battery string or single battery pack level) and can be extrapolated to the higher level, which shares the same construct (e.g., is not more complex or different). Additionally, the systems disclosed can use components that have a lower current rating than that of the battery pack as a whole. Since each battery string is added (or removed) in parallel, and the control of the battery pack is at the battery string level, components like battery string contactors (e.g., the battery contactors 234A, 234A′ 234B, 234B′ and 234C, 234C′ or the battery contactors 334A, 334A′) only need to be rated to the output current of the applicable single battery string. The battery pack, therefore, can have an output of two to four (or more) times the string current output but can still utilize components only rated for the string output current of the single string. This can reduce component costs as the system need not utilize higher load rated components rated for extreme power applications. Additionally, by not having to utilize higher load rated components, system components can be sourced from a larger variety of vendors where supply is not as limited as is the case with those rated for extreme power applications.

From a mechanical assembly perspective, having scalable parts such as the battery strings, battery contacts, etc. and battery packs using the same components has benefits. A single bus bar running across a module of battery packs of identical size, shape and other construction can be utilized. Boxes containing battery pack(s) can be swapped in or out as needed without having to modify connection layout. The present modular design is easier from a mechanical layout perspective as the overall design does not need to accommodate one battery pack of one physical size, shape and/or construction with another of another physical size, shape and/or construction. Rather, the present systems have easily scalable size, shape, parts and architecture that can be scaled up (or down) relatively easily.

The above detailed description is intended to be illustrative, and not restrictive. The scope of the disclosure should, therefore, be determined with references to the appended claims, along with the full scope of equivalents to which such claims are entitled.

What is claimed is:

1. A control system for a battery pack, comprising:
a plurality of battery strings each having an identical construction, each battery string including a plurality of battery cells connected in series;
a plurality of contactors each having an identical construction, wherein each battery string has a respective pair of the plurality of contactors with one of the respective pair connected to a positive terminal and a second of the respective pair connected a negative terminal of each battery string;
a plurality of sensors, wherein each of the plurality of battery strings has a respective one of the plurality of sensors configured to measure at least one of voltage and current; and
a controller connected to the plurality of sensors and the plurality of contactors, wherein the controller is configured to control each of the plurality of battery strings individually to meet a system requirement based upon measurement from the plurality of sensors.

2. The control system of claim 1, wherein the controller is configured to selectively connect or disconnect each of the plurality of battery strings by controlling the respective pair of contactors for each battery string based on the measurement of the respective one of the plurality of sensors.

3. The control system of claim 1, wherein the plurality of battery strings are connected in parallel to combine an output power for the battery pack.

4. The control system of claim 3, wherein the output power of the plurality of battery strings connected in parallel exceeds a rated power output of any one of the plurality of contactors.

5. The control system of claim 1, wherein the identical construction of each of the plurality of battery strings includes a same architecture and same components.

6. The control system of claim 1, further comprising a least a second battery pack connected together in series or parallel with the battery back, wherein the second battery pack has a second plurality of strings having the identical construction of the plurality of battery strings of the battery pack.

7. The control system of claim 1, wherein controller is configured to increase power output of the battery pack by selectively commanding applicable ones of the plurality of contactors to connect additional of the plurality of battery strings and the controller is configured to selectively decrease power output of the battery pack by selectively commanding applicable ones of the plurality of contactors to disconnect one or more of the plurality of battery strings.

8. The control system of claim 1, wherein each of the plurality of contactors is rated to 100 Amperes or less.

9. The control system of claim 1, wherein the identical construction of the plurality of battery strings enables one or more battery strings to be interchangeably added or removed without reconfiguring the controller.

10. A method of controlling a battery pack, the method comprising:
providing a plurality of battery strings each having an identical construction, each battery string including a plurality of battery cells connected in series, wherein each of the plurality of battery strings is connected to a respective pair of contactors;
providing a sensor configured to measure at least one of a voltage and a current of each of the plurality of battery strings, wherein each respective sensor is electrically connected to an electronic controller; and
selectively controlling individually ones of the plurality of battery strings to meet a requirement with the electronic controller based upon measurement from each sensor.

11. The method of claim 10, wherein selectively controlling includes selectively connecting or disconnecting each of the plurality of battery strings by controlling the respective pair of contactors for each battery string based on the measurement of each sensor.

12. The method of claim 10, wherein the plurality of battery strings are connected in parallel to combine an output power for the battery pack, wherein the output power of the plurality of battery strings connected in parallel exceeds a rated power output of any one of the respective pair of contactors.

13. The method of claim 12, wherein each of the respective pair of contactors is rated to 100 Amperes or less.

14. The method of claim 10, wherein the identical construction of each of the plurality of battery strings includes a same architecture and same components, and wherein this same architecture and same components enables the plurality of battery strings to be interchangeably added or removed without reconfiguring the electronic controller.

15. The method of claim 10, further comprising modularly expanding a power output of the battery pack by adding an additional one or more battery strings having the identical construction.

16. The method of claim 10, further comprising providing a least a second battery pack connected together in series or parallel with the battery back, wherein the second battery pack has a second plurality of strings having the identical construction of the plurality of battery strings of the battery pack.

17. The method of claim 10, wherein selectively controlling individually ones of the plurality of battery strings includes adding one or more of the plurality of battery strings in parallel to increase an output current capacity of the battery pack.

18. A method of flexibly scaling a battery system, the method comprising:
providing a baseline battery pack comprising a plurality of battery strings each of the plurality of battery strings having an identical construction;
controlling individual ones of the plurality of battery strings to meet a requirement with an electronic controller; and
adding one or more additional battery strings having the identical construction to the baseline battery pack to increase power output;
wherein the identical construction includes a same architecture and same components for each of the plurality of battery strings including the one or more additional battery strings enabling interchangeably adding battery strings without reconfiguring the electronic controller.

19. The method of claim 18, wherein adding the one or more additional battery strings includes adding one or more battery packs having an identical construction to the baseline battery pack.

20. The method of claim 18, wherein the plurality of battery strings and the one or more additional battery strings are connected in parallel to combine an output power for the battery pack, wherein the output power of the plurality of battery strings and the one or more additional battery strings connected in parallel exceeds a rated power output of one or more of the same components.
